(19) United States
(12) Patent Application Publication
(10) Pub. No.: US 2006/0196895 A1
(43) Pub. Date: Sep. 7, 2006

(54) Tube and orifice having a valve function

(76) Inventor: Rudy Trejo, Corpus Christi, TX (US)

Correspondence Address: Rudy Trejo, 342 Belmont, Corpus Christi, TX, 78418, US

(21) Appl. No.: 11/073,368

(22) Filed: Mar. 4, 2005

(51) Int. Cl. B67D 3/00

(52) U.S. Cl. 222/528

(57) ABSTRACT

This invention relates generally to a sealable straw and ventable closure assembly which provides multiple dispensing techniques designed to be attached to the opening of a variety of known sealable containers and container closures.

### FIELD OF THE INVENTION

This invention relates generally to a sealable straw and ventable closure assembly which provides multiple dispensing techniques designed to be attached to the opening of a variety of known sealable containers and container closures.

### SUMMARY OF THE INVENTION

I have invented a tube and orifice assembly which has multiple valve functions, which provides a sealing means and a venting means for a variety of sealable containers. The tube and orifice will allow a user to selectively open and close the interior of a container.

The sealable tube is provided with a biasing member, anchoring member or a clamping member for maintaining the tube in a sealed state. The members may be provided as an accessory for a tube or may be integrally formed in the tube.

The sealable tube may be provided with or integrally formed with a venting portion and a sealing portion which is designed to cooperate with the tube orifice to provide a venting device for selectively opening and closing the tube orifice. The sealable tube is inserted through the tube orifice such that liquid may be accessed by the user. The venting portion has a cross-sectional area less than the cross-sectional area of the tube orifice. When the user wishes to vent the container he aligns the venting portion with the orifice, which creates a air exchange passage between the peripheral edge of the orifice and the tube. The user may seal the container by pushing or pulling the tube through the orifice. The sealing portion has a cross-sectional area greater or equal to the cross-sectional area of the orifice. When the user wishes to seal the container he aligns the sealing portion with the orifice which creates a fluid type seal.

The invention provides a sealable tube and sealable tube orifice assembly which is used in conjunction with a variety of known container types, such as aseptic flexible pouches, disposable beverage containers, sports bottles and baby bottles. The sealable tube will enable user to easily seal and open the tube with one hand or by the user's mouth. The sealable tube is integrally formed with a venting portion which cooperates with the tube orifice providing a venting device that may be selectively operated to provide either an opening for admitting air into the container for the sipping type operation, or can be manipulated to form a fluid type seal preventing flow of air into the container.

The sealable tube of the invention comprises of a tubular straw which is deformable to and from a first open state and a second sealed state. The tube is retained in the sealed state by a biasing means, anchoring means or a clamping member. The members can be integrally formed in the tube or can be provided as an attachment or accessory for commercially available straws.

In the first preferred embodiment the dispensing sealable tube is maintained in the sealed state by a biasing means. The biasing means which is located at or adjacent to the bending location, is provided for selectively retracting and retaining the dispensing tube in the sealed state. In the open state the structural integrity of the tubular walls exert a force greater than the force exerted by the biasing means, therefore in the open state the biasing means is inactive thereby allowing liquid to pass through the tube. The biasing means is activated by the user squeezing the bending location, thereby bending and collapsing the tubular walls. When in the bent position the biasing means automatically retracts the dispensing tube from the open state to the sealed state. The dispensing tube is easily opened by the user unbending the dispensing tube, which causes the collapsed walls to return to their tubular form. The biasing member may be located at the tip of the straw to allow the user to seal the straw with his mouth, or it may be located between the two open ends to allow the user to seal the straw by squeezing the bending location. The biasing member can be integrally formed in the tube or can be provided as an attachment or accessory for commercially available straws.

In the second preferred embodiment the tube is provided with an anchoring means which is located at or adjacent to the bending location, which is provided for selectively retaining the dispensing tube in the sealed state. When the user manually bends the dispensing tube to a sealed state the anchoring means frictionally engages the dispensing tube thus, maintaining the dispensing tube in the sealed state. When in the sealed state the user must unbend the dispensing tube, thus disengaging the anchoring means from the dispensing tube.

In another preferred embodiment of the invention the tube is inserted through a anchoring sleeve which is mounted to a closure. The anchoring sleeve is provided with an interior passage way which is located in the interior of a container. The tube is provided with interior passage way. The interior passage way will allow liquid or gas to flow from the exterior of the tube to the interior of the tube. When the user wishes to access liquid or gas through the interior passage way, he aligns the anchoring sleeve passage way with the interior passage way of the tube. In order to seal the interior passage way the user pushes or pulls the tube through the anchoring sleeve, such that the anchoring sleeve interior passage way is misaligned with the interior passage way of the tube. The anchoring sleeve is of a diameter that will provide a fluid type seal with the container and the tube.

In another preferred embodiment of the invention, the sealable tube is of a diameter substantially greater than or the same as the orifice such that it provides a fluid type seal when aligned with tube orifice. The sealable dispensing tube is integrally formed with a venting portion which cooperates with the orifice providing a venting device that may be selectively operated to provide either an opening for admitting air into the container for the sipping type of operation, or can be manipulated to form a fluid type seal preventing flow of air into the container.

When the user wishes to vent the container he aligns the venting portion of the straw with the orifice, thus allowing air into the container. When the user wishes to seal the container he pushes or pulls the tube such that the venting portion is misaligned with the straw orifice, thus providing a fluid type seal.

In another preferred embodiment the sealable dispensing tube is of a diameter less than the tube orifice such that when aligned with tube orifice air is allows into the container. The sealable dispensing tube is provided with a sealing portion of a diameter substantially greater than the straw bore such that when aligned with the orifice it provides a fluid type seal.

In another preferred embodiment of the invention the sealable dispensing tube is provided in the form the dispensing tube.

In another preferred embodiment of the invention, the sealable tube is provided in the form of a drinking straw which is bendable at a predetermined bending location along the axis of the straw, from an open state to a sealed state. Bending the tube creases and collapses the tubular walls at the bending location, thereby sealing the tube. A biasing means is provided at or adjacent to the bending location on the tube and selectively maintains the tube in the bent and sealed state.

The tube can be manually straightened by the user unbending the tube, thus removing the collapsed crease and returning the tube to its tubular shape. The structural integrity of the tubular shape maintains the biasing member in the open state, thereby allowing liquid to pass through the tube. In order to seal the tube, the user squeezes the tube at the bending location, thus collapsing the tubular walls, which allows the biasing member to automatically retract the tube to the sealed state.

In another preferred embodiment, the dispensing tube according to the invention is provided by a drinking tube having an open mouth and a beveled bottom end. The beveled bottom is designed to puncture a sealed container.

In another preferred embodiment, the dispensing tube is provided in conjunction with a sealed flexible container. When the tube is in the sealed state, liquid is prevented from squirting upwardly through the straw. When the tube is in the open state, the user may forcibly eject liquid through the tube by squeezing the flexible container.

In another preferred embodiment, the dispensing tube is inserted into a portable beverage container and adapted to allow the user to easily and conveniently drink or dispense beverage contained in a container.

In another preferred embodiment, the dispensing tube is provided in conjunction with a sealed flexible container for the dispensing of lubricating oils and the like.

In another preferred embodiment, the dispensing tube may be equipped with an accordion hinge capable of allowing the user to easily adjust the orientation of the dispensing tube.

In any of the various sealable straw and sealable orifice assembly embodiments of the invention, the tube may be used to dispense liquid from a variety of known containers, or allow the user to easily drink from the container.

BACKGROUND OF THE INVENTION

Portable beverage containers are useful in various environments and situations to provide convenient methods of transporting, storing, and consuming liquid beverages.

There are various types of portable beverage containers which utilize straw and straw orifice assembly which consists of a straw orifice and a protruding straw. One of the reasons for the popularity of the straw is that the use of a drinking straw makes the drinking process more enjoyable, convenient, and efficient in that the straw projects up from the container for easy access. The known straws that have been commonly used are often cylindrical in shape and of uniform diameter throughout their length. Straws of uniformed diameters adapted to be inserted into a sealed container for liquid beverages to enable the user to drink from the container are well-known.

A common type of straw bore is featured on a disposable lid of thin plastic material which is snapped on the top of paper or plastic soft drinks or other containers at fast food restaurants or convenient stores. Most such lids having an access or straw orifice through which a straw can pass for drinking are not sealable.

The proliferation of portable beverage containers has produced the need for a sealable tube and sealable tube orifice, having a dual valve function, for providing a sealing means and a venting means, which can be sealed easily with one hand.

Various combinations of straw and closure assemblies are known in the prior art. These include U.S. Pat. No. 5,167,354 to Cohanfard (1992) discloses a straw and closure assembly which utilizes an accordion hinged straw which is sealed by placing a cap closure over the upper end of the straw and applying downward force, as is illustrated in FIG. 19. Sealing and unsealing this straw is inconvenient, because it requires good hand eye coordination and use of both hands for operation. This makes it very difficult for many users, including small children, the elder, and people with diminished physical skills. Using this straw and closure assembly while operation a moving motor vehicle or riding a bicycle is unsafe because sealing and unsealing and closure assembly also provides a nuisance to the user in that the sealing cap projects into the users' face when drinking. This straw and closure assembly also has the operational disadvantage of tending to come out of the beverage container when the upward force is applied to unseal it. This straw and closure assembly is also hygienically unsafe for repeated us in that cleaning the accordion portion of the straw is difficult. Still another safety disadvantage of this straw and closure assembly is the danger that the cap may be swallowed by a young child if it detaches from the straw.

U.S. Pat. No. 4,502,708 to Mills (1985) discloses a straw which is inserted into a disposable cup. The chief disadvantages of this design are that it is not sealable or spill resistant.

U.S. Pat. No. 5,018,635 to Whittaker (1991) discloses a fluid containment device on beverage cans, which includes a vent closure of the type push to close-pull to open, as illustrated in FIGS. 20, 21, and 22. The operation of the push pull mechanism is cumbersome because its small size and this mechanism is difficult to clean, rendering it unsafe and unsanitary for repeated use. This design is also expensive to manufacture and assemble because of the separate multiple molded parts.

### OBJECT OF THE INVENTION

It is the main objective to provide an easy to seal dispensing tube which would be inexpensive to manufacture.

Another object of the present invention is to provide a reusable dispensing tube that it is made of a plastic that can withstand repeated bending.

Another object of the present invention is to provide a dispensing tube for a variety of non beverage liquids.

Another object of the present invention is to provide an easy to seal dispensing tube which allows the user to easily seal the tube with one hand or by the users mouth. Another object of the present invention is to provide a sealable dispensing tube that may be used with various container types without requiring container modification. Another object of the present invention is to provide a dispensing tube which when in the sealed position is spill proof. Another object of the present invention is to provide a dispensing tube which when in the sealed position the taste and aroma is maintained.

Another object of the present invention is to provide a tube that is a one piece design which does not pose as a choking hazard for toddlers and the like.

Another object of the present invention is to provide a sealable tube that will add value to the container by providing a user friendly dispensing system.

Another object of the present invention is to provide a dispensing tube on which advertising or amusement material may be displayed.

Accordingly, it is a general object of the present invention to provide an improved system by which fluids may be dispensed.

Still another object of the present invention is to provide a tube as an accessory for a standard nursing bottle. The user will simply remove the nipple from the bottle and install a disk with a tube bore hole and the dispensing tube thus permitting a child to easily seal and open the container.

A final object of the invention is to provide a dispensing tube which may be used by small children and people with diminishing skills.

Further objects of the invention will be brought out in the following part of the specification, wherein detailed description is for the purpose of fully disclosing the invention without placing limitations thereon. It is understood that the venting device may be provided independent from the sealable portion of the tube. The invention may be manufactured with only one of the previously mentioned features.

Other objects and the features will be apparent from the following detailed description of the present invention with reference to the attached drawings.

### BRIEF DESCRIPTION OF THE DRAWINGS

In the drawings which form a portion of the original disclosure of the invention:

FIG. 1 is a perspective view of one preferred sealable dispensing tube of the invention in which an exterior biasing sleeve is provided for retracting and maintaining the straw in a bent and sealed state.

FIG. 2 is a perspective view of one preferred sealable dispensing tube of the invention in which an exterior anchoring sleeve is provided for maintaining the straw in a bent and sealed state.

FIG. 3 is a perspective view of one preferred sealable dispensing tube of the invention in which an exterior rubber cap is provided for retracting and maintaining the straw in a bent and sealed state.

FIG. 4 is a perspective view of one preferred sealable dispensing tube of the invention in which a releasable fastener is provided for maintaining the straw in a bent and sealed state.

FIG. 5 is a perspective view of a fragmentary cross-sectional view of the tube and container.

FIG. 6 is a perspective view of one preferred sealable dispensing tube of the invention in which an exterior biasing sleeve is shown in its open position.

FIG. 7 is a perspective view of one preferred sealable dispensing tube of the invention in which the tube is provided with a chisel point bottom end;

FIG. 8 is a perspective view of one preferred sealable dispensing tube of the invention in which an anchoring sleeve is shown in its open position.

FIG. 9 is a cross-sectional view of one preferred sealable dispensing tube of the invention in which a releasable fastener is shown in its open position; in phantom the tube is shown in the sealed state.

FIG. 10 is a partial cross-sectional view of the straw of FIG. 4 taken substantially along line 10-10;

FIG. 11 is a perspective view of one preferred sealable dispensing tube of the invention in which a rubber cap is shown in its open position.

FIG. 12 is a perspective view of the sealable dispensing tube in which a releasable fastener is shown in the sealed state; the dispensing tube is shown cooperating with the orifice providing a venting device.

FIG. 13 is a cross-sectional view of the venting portion aligned with the orifice providing an opening for admitting air into the container.

FIG. 14 is a cross-sectional view of the exterior of the sealable dispensing tube to provide a fluid type seal.

FIG. 15 is a cross-sectional view of the exterior of the sealable dispensing tube aligned with the orifice providing an opening for admitting air into the container.

FIG. 16 is a cross-sectional view of the sealing portion aligned with the orifice to provide a fluid type seal.

FIG. 17 is a fragmentary cross-sectional view of tube and exterior anchoring sleeve shown cooperating with the orifice to provide an opening for admitting air into the container;

FIG. 18 is a fragmentary cross-sectional view of tube and exterior anchoring sleeve shown inserted into the orifice to provide a fluid type seal;

FIG. 19 is a perspective view of the prior art, tube 100 and cap 310 assembly in the sealed position;

FIG. 20 is a perspective view of the prior art, sealable vent assembly in the open position;

FIG. 21 is a perspective view of the prior art, sealable vent assembly in the sealed position;

FIG. 22 is a perspective view of the prior art, sealable vent assembly

FIG. 23 is a photograph of a variety of portable beverage containers that have been drilled to create an orifice that cooperates with the exterior surface of the tube and venting device. The sealable tube is shown in the open position.

FIG. 24 is a photograph of a variety of portable beverage containers that have orifice that cooperates with the exterior surface of the tube and venting device. The sealable tube is shown in the sealed position.

IG. 25 illustrates an exploded view showing a cross-sectional view of a cap for a beverage container. The anchoring sleeve is sealing the orifice of the cap. The anchoring sleeve is provided with a interior passage which is designed to cooperate with the interior passage way of the tube.

FIG. 26 is a photograph of a person using anchoring sleeve toothpick 3000 to remove plaque from their teeth.

FIG. 27 is a photograph of a variety of containers being sealed by Cap/Plug/Seal Capsule Assembly.

FIG. 28 is a cross-sectional view of Threaded Valve Closure

### DESCRIPTION OF THE EMBODIMENTS

This application claims priority of provisional application No. 60/550213 filed on Mar. 4, 2004.

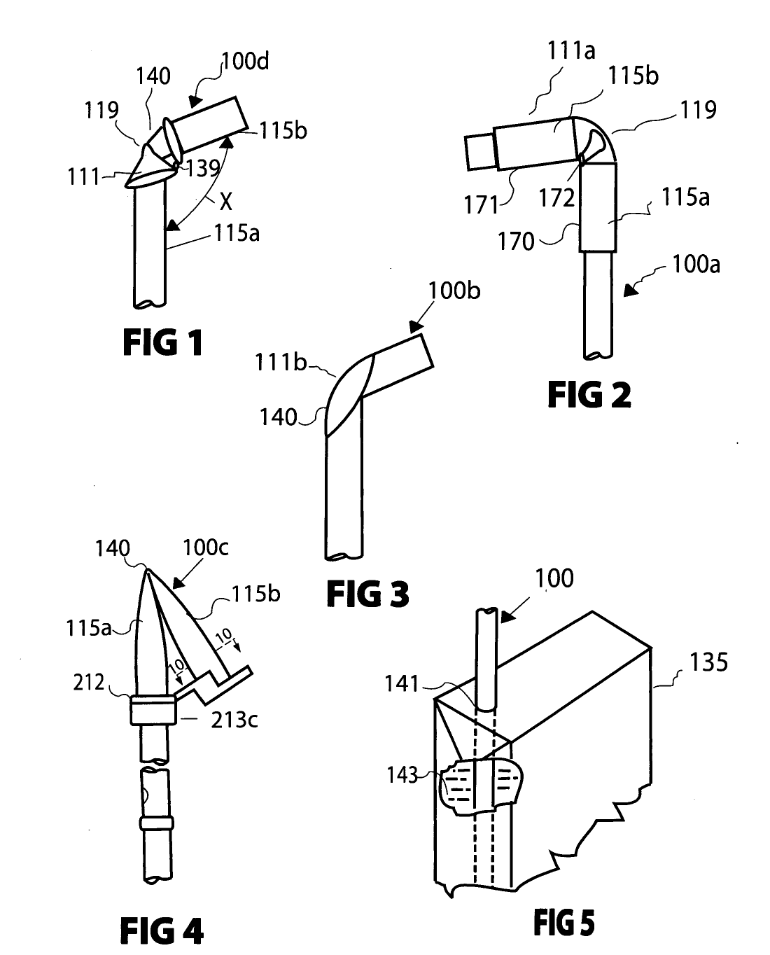

FIG. 1 illustrates the sealable tube 100 in the bent and sealed state. The sealable tube 100 includes a tubular straw which is axially bent into portions 115a and 115b and which is selectively retained in the sealed state by biasing means 111.

As best shown in FIG. 1, the biasing means 111 selectively maintains the sealable dispensing tube 100 in a bent condition so that the tubular walls collapse at the location 140 sufficient to form the crease 119 in the straw, thereby substantially sealing the tubular straw at location 140.

The biasing means 111 as shown in FIG. 1 is provided in the form of a sleeve, made of a resilient and flexible rubber material surrounding the periphery of the straw. The rubber material making up biasing sleeve 111 can be a natural or synthetic rubber or the like and advantageously includes a segment 139 at the ends of biasing sleeve 111. Segment 139 is integrally formed between the two sides of the rubber biasing sleeve 111 and functions to maintain the sealable dispensing tube 100, in the bent and substantially sealed position as illustrated in FIG. 1.

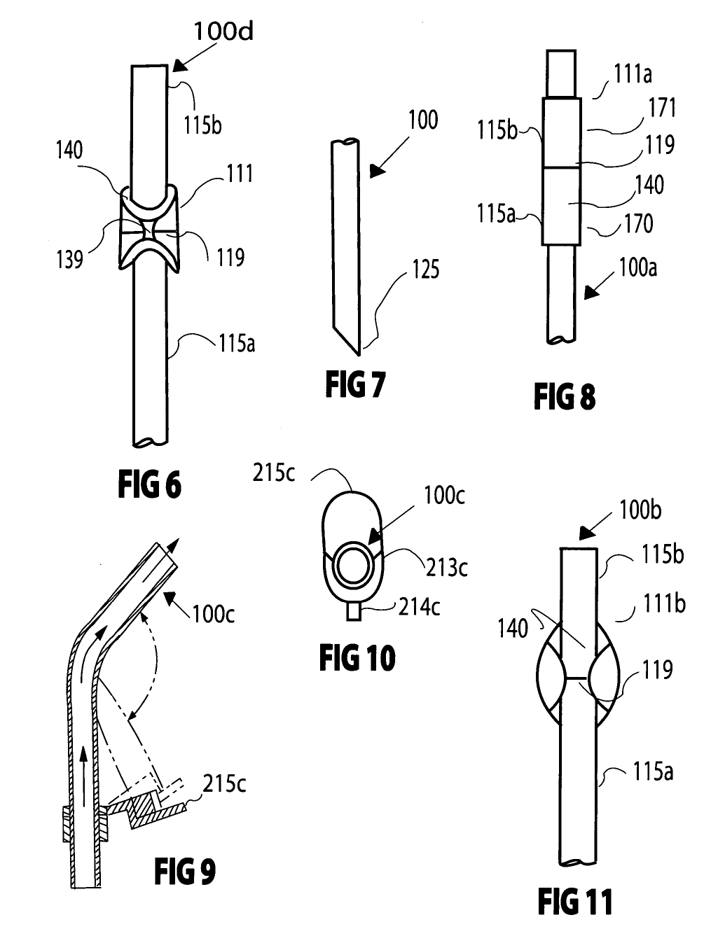

When in its open position, as best illustrated in FIG. 6, the biasing means 111 is not capable of retracting the straw. When the user wishes to seal the dispensing tube 100, he squeezes the bending location 140 of the straw, thus the straw is returned by the biasing means 111 to its closed state. When the user wishes to drink from the sealable dispensing tube 100, the straw is manually deformed to remove the crease 119, thus returning the structural integrity to the straw. Accordingly, the material used to make the straw body, comprising segments 115a and 115b, is advantageously a resilient, preferably plastic, material, so that dispensing tube 100 can be repeatedly deformed to and from the open and closed states.

When maintained in the substantially sealed state shown in FIGS. 1, 2, 3, and 4 the sealable dispensing tube 100 substantially eliminates spillage from a liquid container such as container 135, as illustrated in FIG. 5. A chisel point bottom end 125 of straw 100 as illustrated in FIG. 7 which can be used to puncture seal 130 of container 135 without causing liquid in container 135 to squirt upwardly through straw 100. Similarly, once straw 100 is seated within a relatively snug or tight orifice, such as orifice 141 resulting from puncture of seal 130, spillage of liquid 143 out of container 135 is prevented or minimized as is illustrated in FIG. 5. Thus, the container having a seated sealable dispensing tube 100 as illustrated in FIGS. 1, 2, 3, and 4 can be tipped over without liquid spilling out of the straw. Additionally, the crimp or crease at location 140 also prevents liquid 143 from squirting up through the straw 100 when container 135 is squeezed by the user.

The anchoring means 111a as shown in FIG. 2 is provided in a form of a sleeve of a resilient and flexible plastic material surrounding a portion of the periphery of the straw with a diameter greater v than the diameter of the dispensing tube. The diameter of the anchoring member 111a is such that when in the sealed state the anchoring member 111a frictionally engages and maintains the dispensing tube in the sealed state.

The sealable tube 100 includes a tubular straw which is axially bent into portions 115a and 115b and is selectively maintained by a anchoring means 111a. The anchoring means 111a selectively maintains the tube 100 in a bent condition so that the tubular walls collapse at the location 140 sufficient to form the crease 119 in the straw, thereby substantially sealing the tubular straw at location 140.

The resilient plastic sleeve 111a is attached to the straw 100a adjacent to the bending location 140. The plastic sleeve 111a functions as an anchoring means. The plastic sleeve 111a, in one preferred embodiment is advantageously formed of a flexible and resilient plastic material. The plastic sleeve 111a may be formed by a extrusion process. Following the extrusion process the plastic sleeve 111a is cut such that segment 115a and 115b may be folded such that they are parallel to one another. The anchoring means 111a includes a mounting portion 170 which is located at a predetermined location along the length of the tubular straw 100a. A retaining portion 171 is constructed to frictionally engage the straw 100a and maintain it in the substantially sealed state, and a neck portion 172 extending between the mounting portion 170 and retaining portion 171. As illustrated in FIG. 2. A conventional drinking straw is then threaded through the plastic sleeve 111a. The straw is then bent by the user at the bending location of the plastic sleeve 111a, thus forming crease 119. The straw can be deformed manually to remove the crease 119, to the more straightened position, shown in FIG. 8.

In one preferred embodiment, sleeve 111a and sleeve 111d are edible, formed from all natural ingredients, and can function as a nutritional food product capable of delivering any of a variety of nutritional supplements, such as vitamins, minerals, herbal extracts, or any other type of supplement known in the art. The sleeve 111a and sleeve 111d can be extruded from natural ingredients such as dehydrated fruit or dehydrated vegetable. The extruded sleeve 111a and sleeve 111d may comprise of a combination of fruit powder base mixed with a humectant, natural color, natural flavor, and optionally, one of more nutritional supplements, such as vitamins, minerals, herbal extracts, and the like that are extruded and cut to form the desired straw shape. The extruded sleeve structure is thereafter coated with an edible water repellent coating, such as carnauba wax, shellac or other coatings typically used in the candy industry, and packaged in a moisture proof barrier. FIGS. 3 and 11 illustrate a rubber cap member 111b which is attached to straw 100b at bend location 140 on the transverse top side of the straw. Rubber cap member 111b conforms to the exterior contour of straw 100b. The application of heat to the rubber cap member 111b, fixedly attaches the rubber cap member 111b to the straw 100b. Rubber cap member 111b is advantageously composed of a flexible and resilient rubber material so that straw 100b is selectively biased in the bent position. The rubber cap member 111b is sufficiently flexible about its fold so that the combination of straw 100b and rubber cap member 111b can be readily deformed manually such that the crease 119 is removed.

FIGS. 4 and 9 illustrate yet another preferred embodiment of the invention in which a releasable fastener member 211c is mounted on the upper portion of the straw 100c. As previously described, the straw 100c is sufficiently flexible and resilient such that it can be manually bent along its longitudinal axis into a inverted V-shape defining portions 115a and 115b and selectively maintained in a bent and substantially sealed state by fastener member 211c as illustrated in FIG. 4.

The preferred fastener member 211c is formed of a resilient and flexible plastic material. FIG. 10 is a cross-sectional view of fastener member 211c. The fastener member 211c has a generally tubular portion 212c which is mounted on the upper portion of the straw 100c. A laterally extending portion 214c is integrally formed with a generally C-shaped clamping portion 213c, and a release tab 215c extending from the clamping portion 213c.

The fastener member 211c is sized to maintain the straw 100c in the inverted V-shaped bent condition so that the tubular walls of the straw collapse at location 140 sufficient to form a crimp or crease in the straw, thereby substantially sealing the straw at location 140. The C-shaped portion 213c is configured to receive the bent portion 111b of the straw 100c. The resiliency portion of the straw of the inverted V-shaped bent condition maintains its engagement with the C-shaped clamping portion 213c of the fastener member 211c. The tab member 215c may be pushed downwardly with the thumb or the finger of the user to release the bent portion 115b from C-shaped portion 213c. In the absence of the C-shaped portion 213c, the inherent resiliency of the straw material automatically returns the straw to its normal and relaxed upright position.

FIG. 9 illustrates the sealable tube 100c in its upright position, the collapsed crease at location 140 of the straw 100 opens up to allow liquid to pass through the straw.

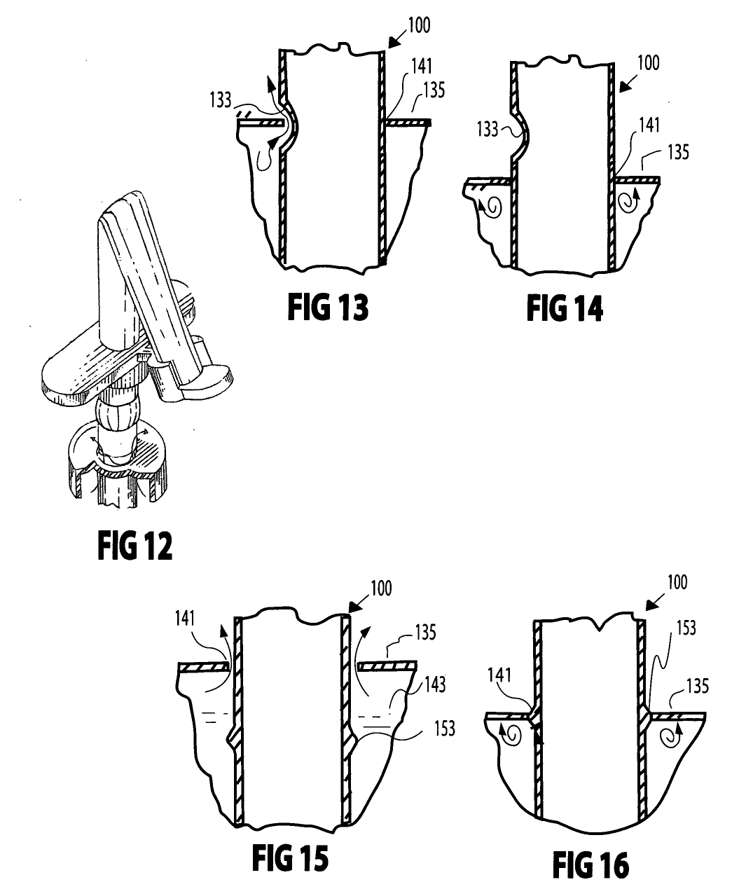

Referring to FIG. 12 the fastener member 211c may also be provided with a horizontally oriented open handle 217c which extend radially outward therefrom.

The sealable dispensing tube is illustrated in FIGS. 6, 8, 9, and 11 in an open position. When a user wishes to drink from the straw, the top segment 115b of the straw is manually deformed by the users hand or mouth, into a more straightened position. Moving the straw to a more straightened position opens the crease 119 at location 140 sufficiently that the crease 119 is removed thereby, returning the structural integrity to the straw.

The sealable tube 100 illustrated in FIG. 1 can be manufactured in various ways. In one method, a conventional straw can be extruded from a polyolefin such as polypropylene in the normal manner and cut into straight straw lengths. The straw is then inserted into a biasing member 111 and the straw/rubber sleeve combination is bent at about the longitudinal mid-point of the rubber sleeve 111 sufficiently to seal the interior of the straw. Typically, the amount of bending is sufficient to seal the interior of the straw and will be an amount sufficient to position the two straw segments 115a and 115b, which are located axially on either side of bending location 140, at an angle X with respect to each other as indicated in FIG. 1. While the straw is held in its bent position, the application of heat or an adhesive applied to the rubber sleeve 111 causing the touching portions of the sleeve on the underside of the straw to melt or adhere together thereby forming integral segment 139.

The tube 100 can be manually straightened by the user unbending the tube 100, thus removing the collapsed crease and returning the tube 100 to its tubular shape. The structural integrity of the tubular shape maintains the biasing member 111 the open state, thereby allowing liquid to pass through the tube 100. In order to seal the tube, the user squeezes the tube at the bending location, thus collapsing the tubular walls, which allows the biasing member to automatically retract the tube to the sealed state.

In another preferred embodiment of the invention in which the sealable dispensing tube 100 is integrally formed with a venting portion 133 which cooperates with the orifice 141, thus providing a venting device that may be selectively operated to provide an opening for admitting air into the container for the sipping type operation, as is illustrated in FIG. 13. The sealable dispensing tube 100 is of the same diameter as the orifice 141 and may be selectively operated to provide a fluid type seal preventing flow of air into the container as is illustrated in FIG. 14.

FIG. 15 illustrates another preferred embodiment of the invention, in which the sealable dispensing tube 100 is integrally formed with a sealing portion 153 which is equal to or greater than orifice 141. When the user wishes to seal the orifice 141 he aligns sealing portion 153 with orifice 141 to provide a fluid type seal. The straw 100 cooperates with orifice 141 to provide a venting device that may be selectively operated to provide either an opening for admitting air into the container for the sipping type operation, as is illustrated in FIG. 15, or can be manipulated to form a fluid type seal preventing flow of air into the container as is illustrated in FIG. 16.

When the user wishes to vent the container he aligns the venting portion 133 of the straw 100 with the orifice 141, thus allowing air into the container as is illustrated in FIG. 13. When the user wishes to seal the container he pushes or pulls the tube 100 such that the venting portion 133 is misaligned with the orifice 141, thus providing a fluid type seal as illustrated in FIG. 14.

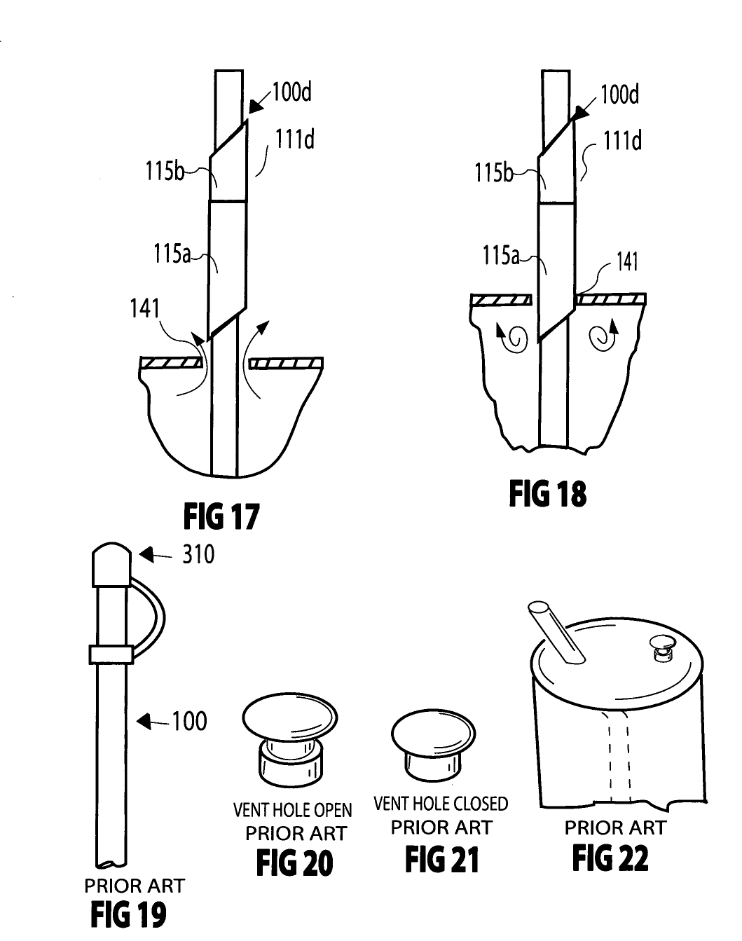

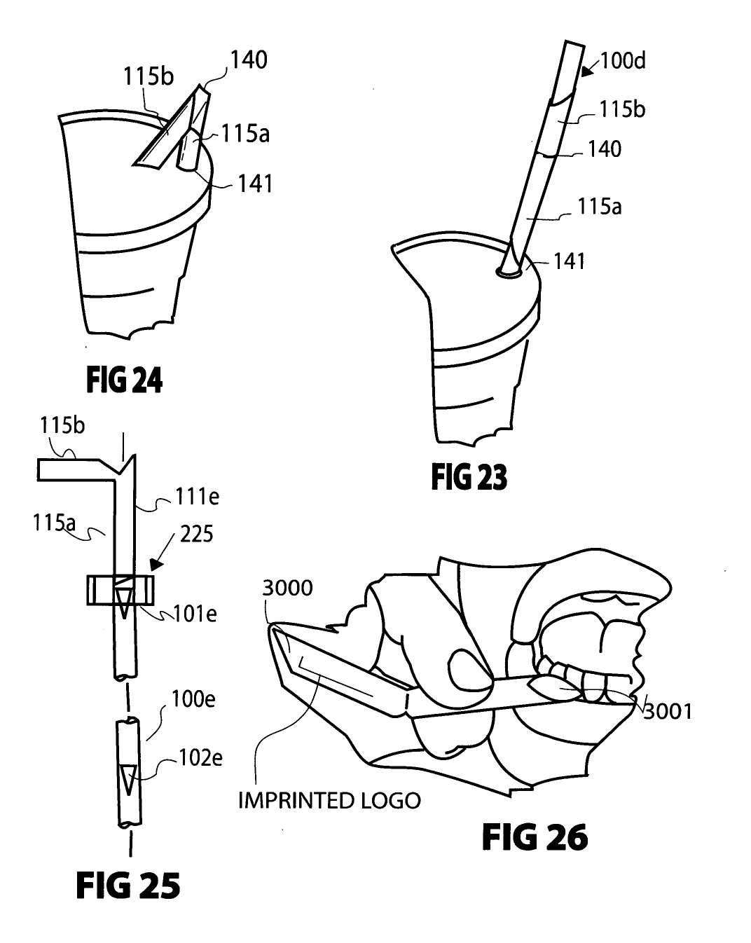

FIG. 17 illustrates another preferred sealable tube 100d of the invention in which a resilient plastic sleeve 111d, is attached or provided as an accessory to the straw 100d adjacent to the bending location 140. The plastic sleeve 111d functions as an anchoring means and as a sealing means. The plastic sleeve 111d is sized and constructed to frictionally engage the orifice 141 as illustrated in FIG. 18. When the user wishes to seal the orifice 141, he inserts plastic sleeve 111d into orifice 141, thus sealing the container 135, as is illustrated in FIG. 18. When the user wishes to vent the container, he removes the sleeve 111d from the orifice, thus providing a gap between the periphery of the straw 100 in the orifice as is illustrated in FIG. 17.

FIG. 25 illustrates an exploded view of another preferred embodiment where the sleeve 111e is provided with an interior passage way 101e below closure 225. Tube 100e is provided with an interior passage way 102e when the passage way 101e is aligned with passage way 102e liquid or gases may flow through the tube. When the user wishes seal the passage way 101e and 102e he pushes or pulls the straws such that the passage ways 101e and 102e are misaligned, thus sealing the passage way 102e. Beveled point 256 may be used as a toothpick.

FIG. 26 is a photograph of an anchoring sleeve toothpick 3000 functioning as a dental toothpick which is formed of a hollow tube body 3002 which allows storage of plaque and small food particles prior to its disposal. The tube body 3002 is provided with deformable chiseled end 3003 which conforms to the gap between two surfaces thus providing a larger contact surface than the prior art plastic toothpick. The profile of deformable chiseled end 3003 is substantially the same as FIG. 7. The deformable chiseled end 3003 is able to fit into small areas that a toothbrush might not reach. Imprinted toothpick anchoring sleeve 3000 is the most inexpensive imprinting medium to advertise a company name, event name, brand, or logo. The user may choose to reduce the risk of cross contamination by covering the end of a conventional drinking straw or valved tube. The toothpick member sleeve 3000 may also be used to seal the end of the conventional drinking straw. The toothpick anchoring sleeve 3000 may also function as a chiseled fork

May be provided with a mint flavor or fortified with fluoride or nutrients. Flexible deformable chiseled ends 3003 are designed such that it is not capable of puncturing human skin. Movie theaters and other places in which popcorn is sold may offer the toothpick anchoring sleeve 3000 as a convenience for their customers. Licensed restaurants and convenient stores will provide the toothpick anchoring sleeve 3000.

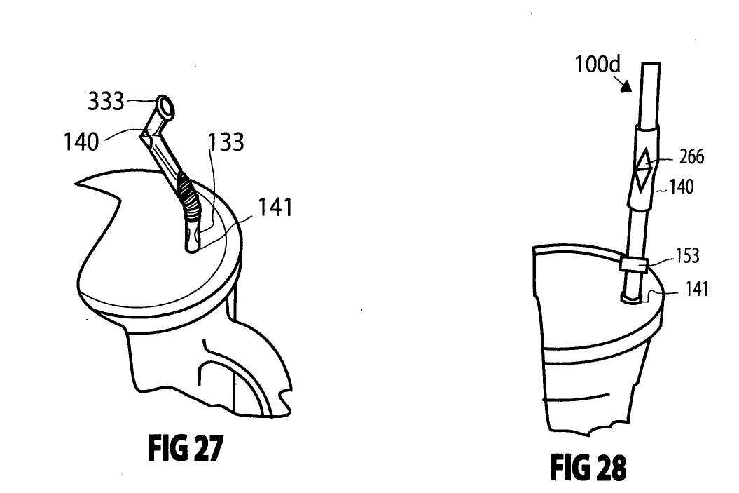

FIG. 27 is a photograph of a variety of containers being sealed by Cap/Plug/Seal Capsule Assembly 4000. Containers 4001 and 4002 are sealed by a diameter less than containers 4003 and 4004. Cap/Plug/Seal Capsule 4005M is designed to seal Containers 4001 and 4002. Cap/Plug/Seal capsule 4006F is designed to plug the opening of containers 4003 and 4004. Cap/Plug/Seal Capsule 4005M is designed to be inserted into Cap/Plug/Seal capsule 4006F forming water tight seal. Container 4003 is sealed by Cap/Plug/Seal Capsule Assembly 4000 may be used to store dry powders or liquids.

FIG. 28 is a cross-sectional view of Threaded Valve Closure 4010 valving the opening of Container 4004. Threaded Valve Closure 4010 is provided with a cavity 4015 to accommodate Valved Tube 4011 in the bent and sealed position, container 4003 with a Cap/Plug/Seal Capsule Assembly 4000. Assembly 4000 is composed of Cap/Plug/Seal 4006F. Valved Tube 4011 is maintained in the bent position projecting beyond the rim 4009 of the Container 4004 such that the user may easily unseal the straw. The user may easily seal the container with one hand or his mouth.

The invention thus provides a sealable tube and squirt resistant straw which can be used with any of various well known containers in order to prevent or minimize spilling of liquids. The sealable dispensing tube 100s provided by the invention can be readily and inexpensively manufactured according to any of various well known plastic manufacturing processes. The straws of the invention are manufactured from commercially available straws by attachment of a biasing means or anchoring means to any of various commercially available straws or can be manufactured to include an integral biasing means or integral anchoring means.

The straws of the invention are simple to use and can be substituted for conventional straws in any of the various known uses thereof. Nevertheless, the sealable dispensing tube 100s according to the invention reliably prevent accidental squirting and spillage of liquids through the straw.

The invention has been described in considerable detail with specific reference to various preferred embodiments thereof. However, variations and modifications can be made without departing from the spirit and scope of the invention as described in the foregoing specification and defined in the appended claims.

What is claimed is:

1. A tube for dispensing the contents within a container, the container having a surface which cooperates with said tube to provide a valve function
a sealing membrane formed as a single thin sheet of material having a substantially uniform thickness, said sealing membrane being sealed to the surface of the container and sealing the container opening
